(19) United States
(12) Patent Application Publication
(10) Pub. No.: US 2018/0194114 A1
(43) Pub. Date: Jul. 12, 2018

(54) LIGHTWEIGHT AUTOMOTIVE LAMINATE WITH HIGH RESISTANCE TO BREAKAGE

(71) Applicant: AGP América S.A., Panama City (PA)

(72) Inventors: Mario Arturo Mannheim Astete, Lima (PE); Charles Stephen Voeltzel, Lima (PE)

(21) Appl. No.: 15/859,427

(22) Filed: Dec. 30, 2017

Related U.S. Application Data
(60) Provisional application No. 62/440,453, filed on Dec. 30, 2016.

(51) Int. Cl. B32B 17/10; C03C 21/00

(52) U.S. Cl. CPC B32B 17/10137; B32B 17/10036; C03C 21/002; B32B 2250/03; B32B 17/10761; B32B 2250/40; B32B 2605/006

(57) ABSTRACT

Working with the traditional soda lime float glass, there is a limit on how thin an automotive laminate can be while still meeting all of the functional and safety requirements. By using alternate glass compositions and chemical tempering, a thinner lightweight automotive laminate, which meets all requirements, and with high resistance to stone chips, has been produced.

### CROSS-REFERENCE TO RELATED APPLICATIONS

This application claims the benefit, under 35 U.S.C. § 119(e)(1), of provisional patent application Ser. No. 62/440,453 titled “Lightweight automotive laminate with high resistance to breakage,” which was filed on Dec. 30, 2016, by the same inventors of this application. The aforementioned provisional application is incorporated herein by reference in its entirety, as if it were disclosed in the present document.

### FIELD OF INVENTION

The present invention relates generally to the field of automotive glass laminate comprising a chemically tempered layer.

### BACKGROUND OF THE INVENTION

In response to the regulatory requirements for increased automotive fuel efficiency as well as the growing public awareness and demand for environmentally friendly products, automotive original equipment manufacturers, around the world, have been working to improve the efficiency of their vehicles.

One of the key elements of this strategy to improve efficiency has been the concept of light weighting. Often times, more traditional, less expensive, conventional materials and processes are being replaced by innovative new materials and processes which while sometime being more expensive, still have higher utility than the materials and processes being replaced due to their lower weight and the corresponding increase in fuel efficiency. Sometimes, the new materials and processes bring with them added functionality as well in addition to their lighter weight. Vehicle glazing has been no exception.

For many years, the standard automotive windshield had a thickness of 5.4 mm. In more recent years, we have seen the thickness decrease to 4.75 mm. While a reduction of 0.65 mm may not seem significant, at a density of 2600 kg per cubic meter for the typical standard soda lime float glass, each millimeter that the thickness is reduced, decreases the weight by 2.6 kg per square meter. The weight of a typical 1.2 square meter windshield going from 5.4 mm to 4.75 mm is reduced by a little over 2 kg. On a vehicle with a total of 6 square meters of glass, a 1 mm reduction on all of the windows translates into a savings of 15.6 kg.

In addition to the weight saved by reducing the glazing thickness, the glazed area of vehicles has been steadily increasing and in the process displacing other heavier materials for further savings. The popular large glass panoramic roofs are just one example of this trend.

However there are limits as to have thin the glazing can be with an annealed soda lime glass construction. The windshield must have sufficient strength to hold up under the stress induced by wind load. With the trend towards increasing the size of windshields in particular, even more strength is needed. Glass is also becoming a structural element in more and more vehicles. The glazing now contributes to the stiffness and strength of the car. Fixed glass, once bonded with a relatively soft curing poly-urethane, is being mounted with higher modulus adhesives. As a result, the glass, once isolated by rubber gaskets and soft butyl adhesives, is now much more subject to loading from the bumps in the road and vehicle torsion.

Today, windshields with a 2.1 mm outer ply or layer 12, a 1.6 mm inner ply or layer 14 and a 0.76 mm plastic interlayer 10 totaling just under 4.5 mm in total thickness are becoming common (FIG. 1). This may be close to the limit of what can be done with conventional annealed soda lime glass.

Annealed glass is glass that has been slowly cooled from the bending temperature through the glass transition range. This is done to relieve stress in the glass. Annealed glass breaks into large shards with sharp edges. In a laminate, two layers 12, 14 of annealed glass are glued together using a layer of thermo plastic 10 situated between the major faces 2, 3 of said glass layers (FIG. 1). If the laminated glass should break, the plastic interlayer 10 holds the shards of glass together, helping to maintain the structural integrity of the glass. The shards of broken glass tend to interlock much like the pieces of a jigsaw puzzle A vehicle with a broken windshield can still be operated, often for an extended period if the damage is not in the vision zones or too extensive. On impact, the plastic interlayer 10 also helps to prevent penetration by the occupant in the event of a collision or by objects striking the laminate from the exterior of the vehicle.

To make a thinner windshield, the glass needs to be stronger. Two processes can be used to increase the strength of glass. They are heat treating, in which the temperature of hot glass is rapidly cooled and chemical tempering which achieves the same effect through a chemical treatment.

Heat strengthened, full temper soda lime float glass, with a compressive strength in the range of at least 70 MPa, can be used in all vehicle positions other than the windshield. Heat strengthened (tempered) glass has a layer of high compression on the outside surfaces of the glass, balanced by tension on the inside of the glass which is produced by the rapid cooling of the hot softened glass. When tempered glass breaks, the tension and compression are no longer in balance and the glass breaks into small beads with dull edges. Tempered glass is much stronger than annealed laminated glass. The thickness limits of the typical automotive heat strengthening process are in the 3.2 mm to 3.6 mm range. This is due to the rapid heat transfer that is required. It is not possible to achieve the high surface compression needed with thinner glass using the typical blower type low pressure air quenching systems.

Glass can also be chemically tempered. In this process, ions in and near the outside surface of the glass are exchanged with ions from the bath that are larger. This places the outer layer of glass in compression. Compressive strengths of up to 1,000 MPa are possible.

Chemical tempering is performed by immersing the glass in a bath of molten potassium nitrate. During the process, potassium ions replace ions of smaller elements in the glass surface creating a compression layer. The tempered strength is a function of the time that the glass is treated, the temperature of the bath, and the glass composition. The strength correlates to the depth of the compression layer. Typical parameters for chemical tempering are treatment at a temperature ranging from 350° C. to 475° C. for a period from 2 to 24 hours.

Unlike heat tempered glass, chemically tempered glass breaks into shards rather than the small bead typical of heat treated glass. This property allows for its use in windshields. However, in standard windshield glass thicknesses of 2.0 mm or greater, chemically strengthened glass would actually be too strong. In the event of a crash and a head impact, the windshield must break, absorbing the energy of the impact rather than the head of the occupant. Therefore, depending upon the tempered strength, thicknesses of 1.0 mm or less must be used in windshields.

In the bullet resistant glazing market, two glass compositions commonly used are borosilicate glass and aluminosilicate glass.

Borosilicate glass is a type of glass that contains boric oxide. It has a low coefficient of thermal expansion and a high resistance to corrosive chemical. It is commonly used to make light bulbs, laboratory glassware, and cooking utensils.

Aluminosilicate glass is made with aluminum oxide. It is even more resistant to chemicals than borosilicate glass and it can withstand higher temperatures. Chemically tempered Aluminosilicate glass is widely used for displays on smart phones and other electronic devices.

In an attempt to reduce weight beyond what is possible with soda lime glass, hybrid glazings have been produced using a chemically tempered aluminosilicate layer of thin glass for the inner layer 14 and an annealed soda-lime glass layer for the outer layer 12 (FIG. 1). The aluminosilicate, while having the potential for up to 1000 MPa at 0.7 mm thickness, does not hold up well to stone impacts. As a result, it must be used for the inner layer 14. The soda lime glass outer layer 12 is no stronger or durable than the outer layer of an ordinary windshield. Due to the flexibility of the thin inner layer 14. However, stone chip resistance in improved by a factor of two. Upon impact, the surface of glass will flex more so than an ordinary windshield, partially absorbing some of the energy of impact.

Another problem faced when transitioning to the thinner soda-lime glass alternatives is that they are typically only available in a clear color. This is in contrast to the hundreds of variations in compositions and coatings that are available in standard windshield thickness soda lime glass. The soda lime variations are primarily targeted at solar load control but also serve an aesthetic function. Thus we are faced with the loss of the solar performance when designing with thinner glass.

It would be advantageous to be able to produce an even thinner laminate, with greater resistance to breakage and enhanced solar performance.

### SUMMARY OF THE INVENTION

It is an object of the present invention to provide an improved laminate.

This object can be attained by a laminate comprising two glass layers, an inner layer and an outer layer; wherein the inner layer is fabricated from aluminosilicate glass with a thickness of less than or equal to 1 mm, and the outer layer is fabricated from borosilicate glass with a thickness of less than or equal to 2.1 mm. Furthermore, the laminate comprises at least one plastic interlayer situated between the major faces of said glass layers and serving to bond said glass layers to each other. Additionally, the inner layer is chemically tempered.

### DESCRIPTION OF THE FIGURES

FIG. 1 is a conventional laminate cross section according to prior art;

FIG. 2 is a laminate cross section with coatings on surfaces one, two and four according to the present invention;

FIG. 3 is a laminate cross section with laminated film and coatings on surfaces one and four according to the present invention;

FIG. 4 is a laminate cross section with coatings on surfaces one, three and four according to the present invention.

### KEY TO THE DRAWING NUMERALS

1 Surface one

2 Surface two

3 Surface three

4 Surface four

10 Plastic Interlayer

12 Outer glass layer

14 Inner glass layer

20 Coating

22 Coating

24 Coating

26 Coating

28 Film

### DETAILED DESCRIPTION OF THE INVENTION

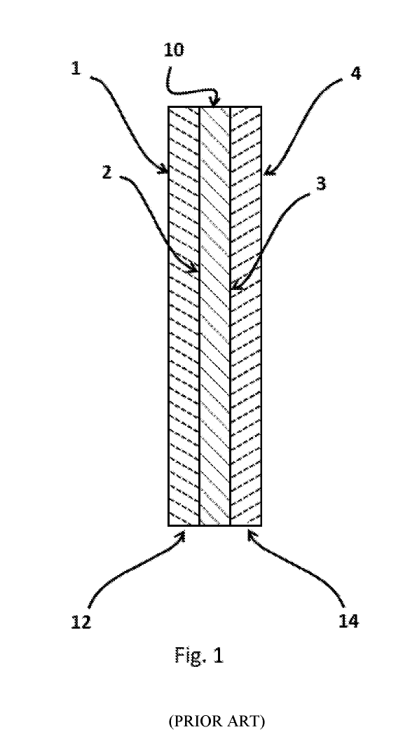

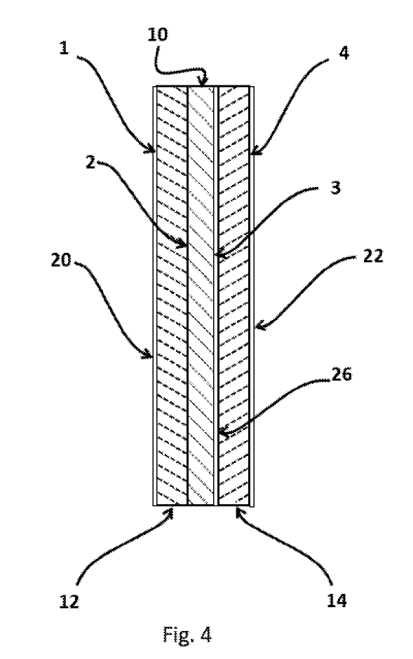

As shown in FIGS. 1-4, standard terminology is used to describe the configuration of a laminated glazing wherein a normal automotive windshield is comprised of two layers of glass: an outer layer 12 and an inner layer 14, which are permanently bonded together with a plastic interlayer 10. The glass surface that is on the outside of the vehicle is referred to as surface one 1. The opposite face of the outer layer of glass 12 is surface two 2. The glass surface that is on the inside of the vehicle is referred to as surface four 4. The opposite face of the inner layer of glass 14 is surface three 3.

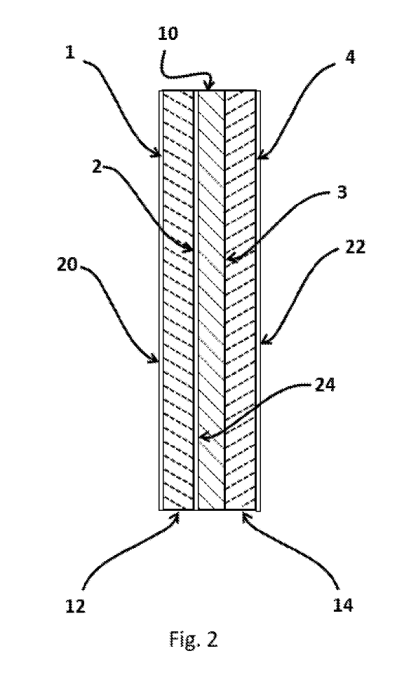

Now referring to FIGS. 2-4, the laminate of the invention utilizes an inner layer 14 of glass having a thickness of less than or equal to 1 mm, an aluminosilicate composition and chemically tempered with a depth of layer of at least 20 μm. This provides for a flexible yet strong substrate that can provide the support needed to hold up under wind load but yield under occupant impact.

For the outer layer 12, annealed borosilicate glass, having a thickness equal to or less than 2.1 mm is used. Borosilicate was selected for its extreme hardness and resistance to breakage. Ordinary borosilicate, for the same thickness, is five times as resistance to stone chips as ordinary soda-lime glass. Combined with an aluminosilicate inner layer 14, the stone resistance is as high as ten times that of soda-lime glass windshields.

With a 0.38 plastic interlayer 10, a maximum total thickness of 3.48 is achieved. Even thinner compositions are possible. It should also be noted that the density of borosilicate glass is less than that of soda-lime glass. Borosilicate is 12% lighter for an additional weight savings.

Compared to the 4.5 mm windshield discussed earlier, the windshield of this cross section is close to 3 kg lighter per square meter. Going to a 1.6 mm borosilicate outer layer 12 increases the weight savings to 3.6 kg per square meter.

The typical stone impact leaves a defect in the glass that is on average 20-30 μm deep. To further improve upon the stone chip resistance a hard coat 20 can be applied to the outside surface 1 of the outer layer 12. Such coatings are well known in the art. They can be applied by vacuum sputtering, spray coating, dip coating or by any other sufficient means of coating know in the art. A sol-gel is a preferred method as the coating can be easily applied by spray or dip coating and the coating can be cured during the bending process. The hard coat 20 serves to absorb additional energy from the impact and further limit the depth of the defect preventing failure the glass layer under all but the most severe cases.

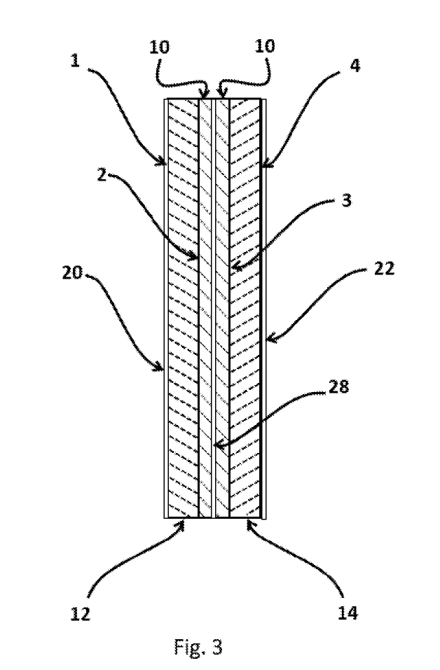

To add solar properties, surfaces one 1, two 2, three 3 and/or four 4 can be coated with a coating 20, 22, 24, 26 that reflects or absorbs heat or that functions in some combination of the two. Again, any means know in the art can be used such as a vacuum sputtered metallic coating, a pyrolytic, a sol-gel or others. Alternately, a performance film layer 28 (FIG. 3), which reflects or absorbs heat or functions in some combination of the two, can be added to the laminate.

To further increase the utility to the final customer, additional coatings (not shown) can be included on the surface four 4 of the inner layer of glass 14. This include but are not limited to anti-reflective, easy clean, finger print resistance and self-cleaning. Again, any means know in the art can be used such as a vacuum sputtered metallic coating, a pyrolytic, a sol-gel or others as appropriate for the type of coating selected. Any such coating however, must be done after the glass has been bent and chemically tempered. Most coatings will interfere with or be damaged by the chemical tempering process.

### Embodiment 1

### Outer Layer

Borosilicate glass 2.1 mm with scratch resistance coating on surface 1 and with IR coating on surface 2

### Plastic Interlayer

0.76 mm PVB

### Inner Layer

Aluminosilicate glass 0.7 mm with anti-reflective coating, anti-fingerprints and easy to clean on surface 4

### Embodiment 2

### Outer Layer

Borosilicate glass 1.75 mm with scratch resistance coating on surface 1 and with IR coating on surface 2

### Plastic Interlayer

0.76 mm PVB

### Inner Layer

Aluminosilicate glass 0.55 mm with anti-reflective coating, anti-fingerprints and easy to clean on surface 4

### Embodiment 3

### Outer Layer

Borosilicate glass 1.6 mm with scratch resistance coating on surface l and with IR coating on surface 2

### Plastic Interlayer

0.38 mm PVB

### Inner Layer

Aluminosilicate 0.3 mm with anti-reflective coating, anti-fingerprints and easy to clean on surface 4

### Embodiment 4

### Outer Layer

Borosilicate glass 1.75 mm with scratch resistance coating on surface 1and with IR coating on surface 2

### Plastic Interlayer

0.76 mm PVB

### Inner Layer

Aluminosilicate 0.55 mm with anti-reflective coating, anti-fingerprints and easy to clean on surface 4

The forms of the invention shown and described in this specification represent illustrative preferred embodiments and it is understood that various changes may be made without departing from the spirit of the invention as defined in the following claimed subject matter.

1. A laminate comprising
a. Two glass layers, an inner layer and an outer layer;
b. The inner layer having a thickness of less than or equal to 1 mm
i. Fabricated from aluminosilicate glass
ii. And chemically tempered;
c. The outer layer having a thickness of less than or equal to 2.1 mm
i. Fabricated from borosilicate glass;
d. At least one plastic interlayer;
e. Said at least one plastic interlayer situated between the major faces of said glass layers and serving to bond said glass layers to each other.

2. The laminate of claim 1 further comprising a protective hard coat applied to the outer layer.

3. The laminate of claim 1 further comprising at least one coating selected from the group consisting of heat reflecting coatings and heat absorbing coatings.

4. The laminate of claim 1 further comprising at least one film selected from the group consisting of heat reflecting films and heat absorbing films.

5. The laminate of claim 1 further comprising a coating applied to the surface four of the inner layer, wherein said coating is selected from the group consisting of an anti-reflective coating, an easy to clean coating, a finger print resistance coating and a self-cleaning coating.

6. The laminate of claim 1, wherein the outer layer is chemically tempered.
